(19) United States
(12) Patent Application Publication
(10) Pub. No.: US 2015/0242891 A1
(43) Pub. Date: Aug. 27, 2015

(54) METHOD AND SYSTEM FOR MATCHING COMMERCIAL PRODUCTS TO USERS OF MOBILE APPLICATIONS

(71) Applicant: Kinetic Art Ltd., Ramat Gan (IL)

(72) Inventor: David MIMRAN, Tel Aviv (IL)

(73) Assignee: Kinetic Art Ltd., Ramat Gan (IL)

(21) Appl. No.: 14/189,420

(22) Filed: Feb. 25, 2014

(51) Int. Cl. G06Q 30/02; G06F 17/30

(52) U.S. Cl. CPC G06Q 30/0255; G06F 17/30876; G06F 17/30598; G06Q 30/0267

(57) ABSTRACT

The present invention discloses a method for matching products sale promotions for users while using an application in a computer device. The method comprising the steps of: tracking user usage of application and/or usage of the computer device, including at least path of navigation, activities and context when using an application, aggregating and analyzing usage data of each user in relation to at least one application for identifying behavior pattern, user characteristics and user preferences, updating user profile based on identifying behavior pattern user characteristics and user preferences and matching product commercial in real-time to user while using the application, based on his updated profile and current usage of the application according to predefined triggering rules.

### BACKGROUND

1. Technical Field

The present invention relates generally to matching commercial products based on user behavior within mobile applications, and more particularly, the present invention relates to analyzing user usage of mobile applications and mobile device parameters and introducing matching commercial products.

2. Discussion of Related Art

The known is the art of product matching is based only on user behavior when surfing Web, not considering the usage of the computer device and the timing of promoting the product sale.

### BRIEF SUMMARY

The present invention discloses a method for matching products sale promotions for users while using an application in a computer device. The method comprising the steps of: tracking user usage of application and/or usage of the computer device, including at least path of navigation, activities and context when using an application, aggregating and analyzing usage data of each user in relation to at least one application for identifying behavior pattern, user characteristics and user preferences, updating user profile based on identifying behavior pattern user characteristics and user preferences and matching product commercial in real-time to user while using the application, based on his updated profile and current usage of the application according to predefined triggering rules.

The process of tracking and updating and matching are performed by at least one processor unit.

According to some embodiments of the present invention the tracking user usage include measuring time usage parameters.

According to some embodiments of the present invention the tracking user usage includes measuring parameters of mobile device sensors or hardware elements.

According to some embodiments of the present invention the tracking user usage includes identifying interruptions in application usage including switching between applications.

According to some embodiments of the present invention the tracking user usage includes Identifying network connections.

According to some embodiments of the present invention the aggregating and analyzing usage data includes analyzing consumed content for classifying content, by applying at least one of: text parsing, image recognition, music/voice recognition.

According to some embodiments of the present invention the aggregating and analyzing usage data includes identifying and recording history/sequence of application activation, or simultaneous activation of multiple application.

According to some embodiments of the present invention the aggregating and analyzing usage data includes retrieving metadata information related running application including at least one of the following: category, description, reviews from network.

According to some embodiments of the present invention the tracking is applied to multiple different applications installed on the same computer device and product matching is applied for a current running application of the same computer device.

According to some embodiments of the present invention the product promotion is performed in real-time upon detecting the occurrence of predefined triggering timing rules based on user tracked activities.

The present invention discloses a system for matching products sale promotions for users while using an application in a computer device. The system comprising of, a commercial agent module residing on the computer device for tracking user usage of application and/or usage of the computer device, including at least path of navigation, activities and context when using an application and a network server for aggregating and analyzing usage data of each user in relation to at least one application for identifying behavior pattern, user characteristics and user preferences updating user profile based on identifying behavior pattern user characteristics and user preferences and matching product commercial in real-time to user while using the application, based on his updated profile and current usage of the application according to predefined triggering rules.

According to some embodiments of the present invention the commercial agent module is implemented as a designated application running on the computer device.

According to some embodiments of the present invention the commercial agent module is implemented as a module associated with an application residing on the computer device.

According to some embodiments of the present invention the at least part of the identification and analysis steps are performed at the commercial agent at the computer device of the client

According to some embodiments of the present invention the tracking user usage includes identifying interruptions in application usage including switching between applications.

According to some embodiments of the present invention the aggregating and analyzing usage data includes analyzing consumed content for classifying content, by applying at least one of text parsing, image recognition, music/voice recognition.

According to some embodiments of the present invention the aggregating and analyzing usage data includes identifying and recording sequence of application activation, or simultaneous activation of multiple application.

According to some embodiments of the present invention the aggregating and analyzing usage data includes retrieving metadata information related running application including at least one of the following: category, description, reviews from network.

According to some embodiments of the present invention the tracking is applied to multiple different applications installed on the same computer device and product matching is applied for a current running application of the same computer device.

According to some embodiments of the present invention the product promotion is performed in real-time upon detecting the occurrence of predefined triggering timing rules based on user tracked activities.

### BRIEF DESCRIPTION OF THE DRAWINGS

The present invention will be more readily understood from the detailed description of embodiments thereof made in conjunction with the accompanying drawings of which:

FIG. 1 illustrates a high level block diagram of an environment of the present invention, according to some embodiments of the invention;

FIG. 2 shows a flowchart diagram illustrating activity of identifying module, according to some embodiments of the invention;

FIG. 3 shows a flowchart diagram illustrating activity of Context usage analysis module, according to some embodiments of the invention;

FIG. 4 shows a flowchart diagram illustrating an activity of product matching engine, according to some embodiments of the invention;

FIG. 5 shows a flowchart diagram illustrating an activity of commercial agent at the client communication device, according to some embodiments of the invention;

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term “computerized device” as used herein in this application, is defined as any device with processing capabilities such as a processing device, a computerized mobile device such as Smartphone and a tablet.

Embodiments of the present invention provide a method and system for improving a process of discovering application programs that are published in an electronic market of computer applications, such the Apps stores of Apple. The application programs may be installed on a computerized device or optionally installed on a personal computer. The market place of applications may be provided through any data communication network such as the Internet.

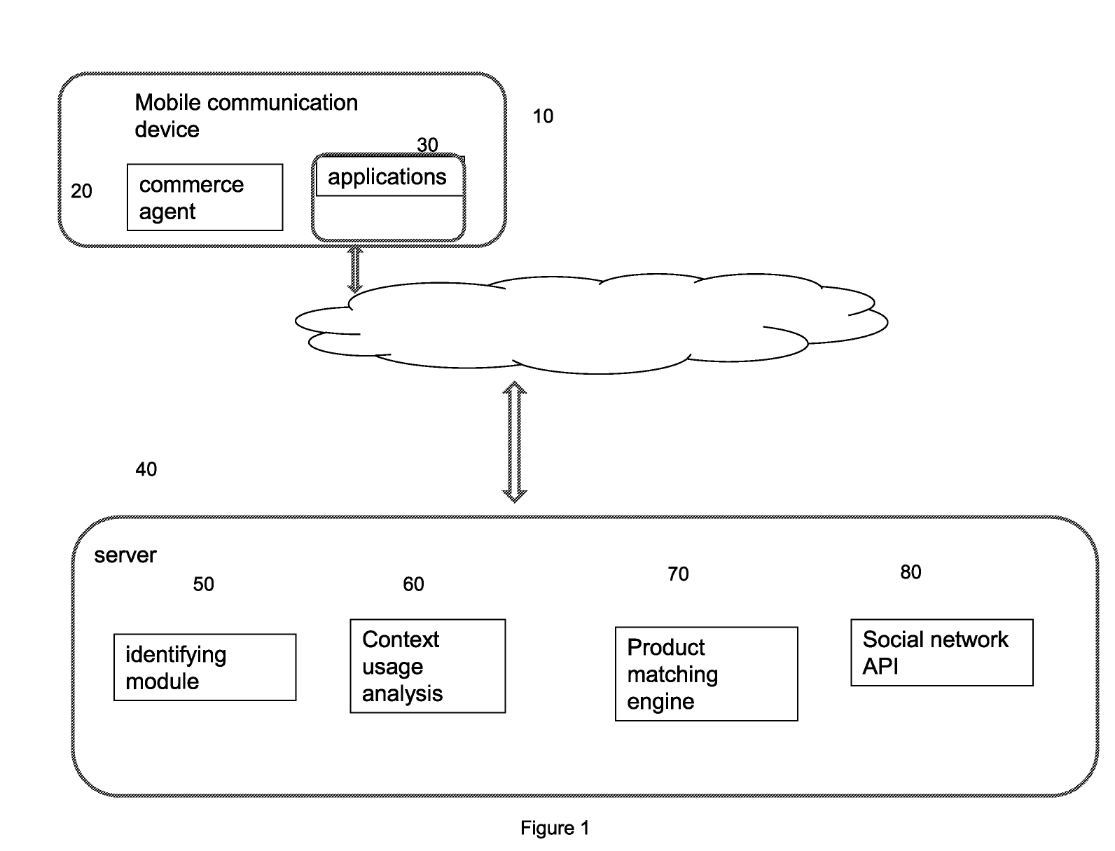

FIG. 1 illustrates a high level block diagram of an environment and the components of the present invention, according to some embodiments of the invention. The system according to the present invention is comprised of commercial/product agrnt module 20 at the user's communication device 10 for tracking user's activities providing real-time customized product commercial based on matching commercial promotion received from the product matching engine. The system on server side includes identifying module 50 for aggregating and accumulating user usage activities, Context usage analysis modules 60 for building user profiles, product matching engine 70 for determining customized product commercial for each user and social network API 80 for retrieving personal information of user from social networks of other sources. Accordingly the present invention enables to take into consideration promotion timing, type of products and user preferences and characteristics for predicting user interest in commercial product and optimizing his interest level.

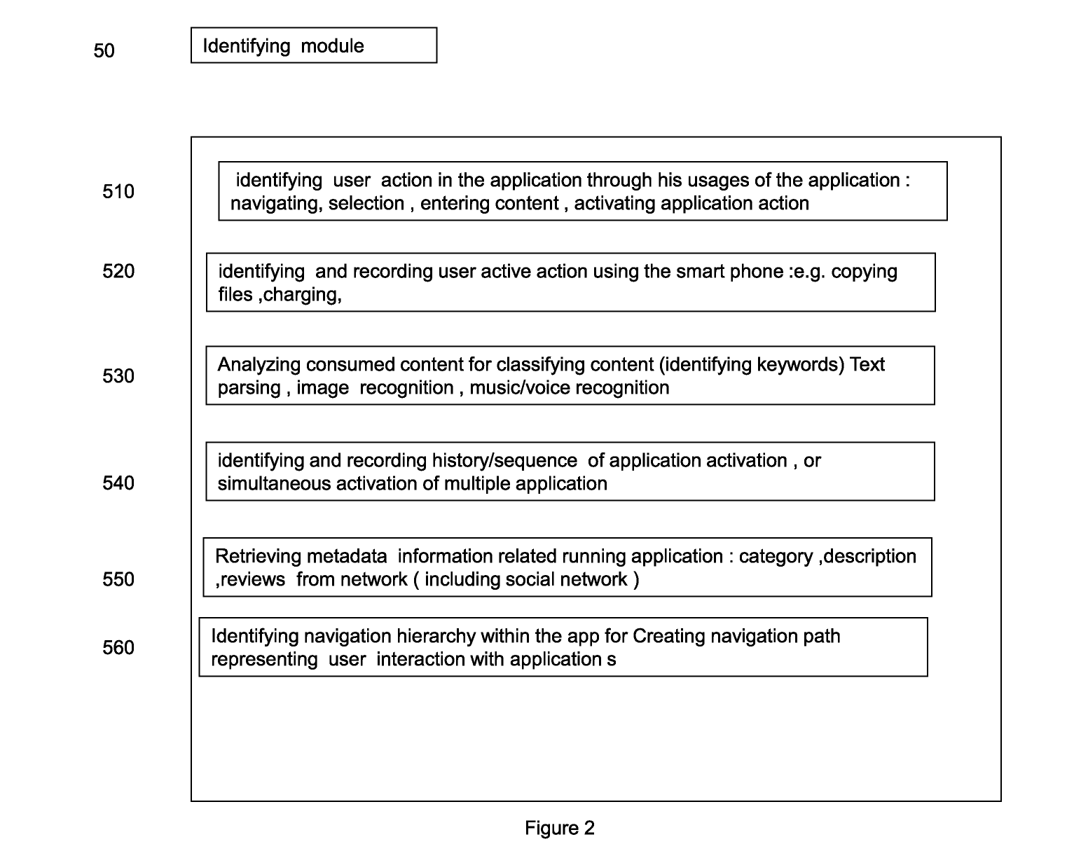

FIG. 2 shows a flowchart diagram illustrating activity of identifying module, according to some embodiments of the invention. The identifying module preforms at least one of the following steps: identifying and recording user active actions in application through his usages of the application: selection, entering content, navigating, activating application action (step 510) including navigation in application screens, activating functionalities of the application or preforming search by specific key words, entering content(text, image, video), identifying and recording user active action using the smart phone: e.g. copying music files, charging (step 520). The module further processes the identified actions, by applying at least one of the following: analyzing consumed content for classifying content (identifying keywords) Text parsing, image recognition, music/voice recognition, (step 530), identifying and recording history/sequence of application activation, or simultaneous activation of multiple applications (step 540), such as running navigation or sport application is the background. At the end of the analysis, the module Identifies navigation hierarchy within the app for creating navigation path representing user interaction with application (step 560). According to some embodiments of the present invention the module further retrieves metadata information related to the running application: category, description, reviews from network (including social network) (step 550).

According to some embodiments, at least part of the identification and analysis steps as described above, may be performed at the commercial agent at the computer device of the client.

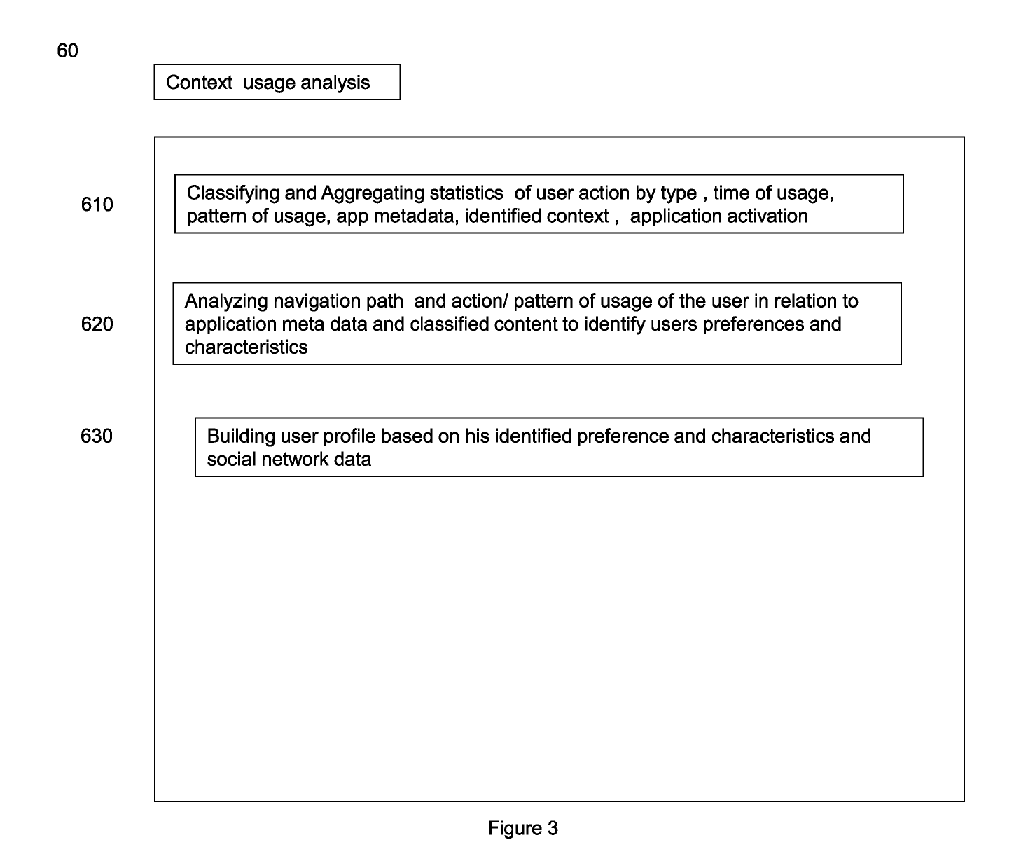

FIG. 3 shows a flowchart diagram illustrating the activity of Context usage analysis module, according to some embodiments of the invention. The Context usage analysis module preforms at least one of the following steps: Classifying and aggregating statistics of user action by type, time of usage, pattern of usage, app metadata, identified context, application activation (step 610), analyzing navigation path and action/pattern of usage of the user in relation to application meta data and classified content to identify users preferences and characteristics (step 620) and/or building user profile based on his identified preference and characteristics and social network data (step 630).

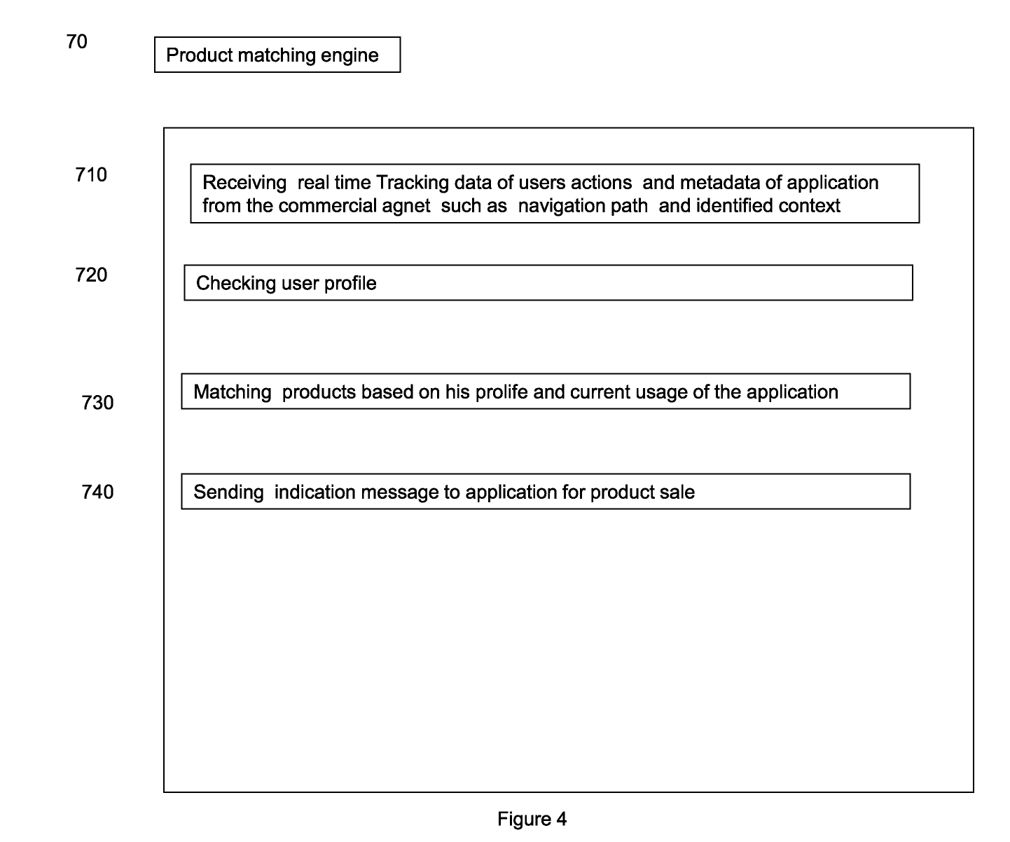

FIG. 4 shows a flowchart diagram illustrating the activity of product matching engine, according to some embodiments of the invention. The product matching engine, preforms at least one of the following steps: real-time tracking users actions and navigation path within the application (step 710), checking user generated profile (step 720), matching content or adds based on user's prolife and current usage of the application according to predefined rules based on user preferences and characteristics (step 730). For example a user navigating through guiding tour application at specific location may be presented with personalized content of specific products based on his interest which are relevant for his specific location. At the last step sending indication message to application for product promotion (step 740).

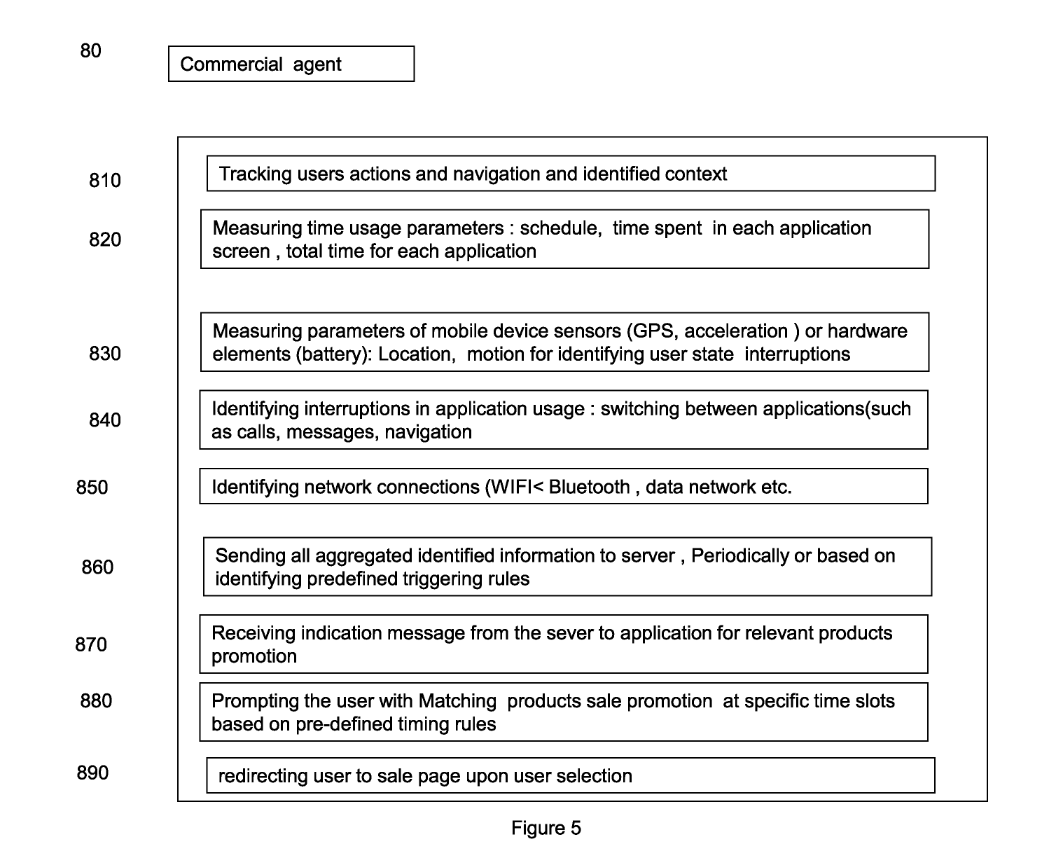

FIG. 5 shows a flowchart diagram illustrating an activity of commercial agent at the client communication device, according to some embodiments of the invention. The commercial agent, track and measure at least one of the activities and parameters: Tracking users actions and navigation and identified context (step 810), Measuring time usage parameters: schedule, time spent in each application screen, total time for each application (step 820), Measuring parameters of mobile device sensors (GPS, acceleration) or hardware elements (battery): Location and motion for identifying user state (step 830), Identifying interruptions in application usage: switching between applications(such as calls, messages, navigation or simultaneous activation of multiple application (step 840), identifying network connections (WIFI<Bluetooth, data network etc. (step 850). All aggregated identified information is sent to server, periodically or based on identifying predefined triggering rules (step 860). The agent receives indication message from the sever of relevant products promotion which match user current activity (step 870) and prompts the user with Matching products sale promotion at specific time slots based on pre-defined timing rules. (step 880). In case, the user selects a product promotion, the user is redirected to a sale page (step 890).

The commercial agent can be implemented as independent application running on mobile application which is associated with designated applications or as part of a designated application.

According to some embodiments of the present invention the following examples scenarios can be implemented:

### First Scenario

A user opens up a cooking application, the user search/navigates to pasta recipes for make pasta. Every time the user moves to the next pasta recipe (or according to predefined triggering rule) the agent within the app (or on the computer device) sends a report to the server notifying that the specific user (identified by his device ID) is watching a pasta recipe for x seconds. The server receives the activity reports and identifies the context of user activity (i.e. a growing interest in pasta) and match or filters out pasta related products from products database and sorts it by popularity based on the user profile preferences and characteristics(i.e the user prefers organic food). The respective list of matching products is sent by the server to agent module on the user commuter device which prompts the user with the top list of pasta related products commercial for sale at specific time spot when detecting specific triggering activity rule such as when the user is reading the ingredients of another pasta recipe.

### Second Scenario

The agent application or modules detects the following actions performed by the user and reports to the server: user bought a new phone, installs a calendar app, the user is copying multiple music files to the file folder, the user is downloading a running sport application. The agent residing inside the calendar app (running at the background) detects that the user is currently running, identifies the user stopped running after 10 miles and connected to WIFI network, all actions are reports it to the server. The server analyzes all action including: evaluating the properties/conditions of a new phone, amount of music files, end of run, and WFI connectivity and determines according to predefined triggering rules the proper time to send proposal for buying new running matching products, such as headphones to the agent. For example when the user enters the calendar to view tasks, he receives promotion of the headphones.

### Third Scenario

The agent is implemented inside a messenger application. The agent track users action of opening messenger and sends a message to a friend about going shopping together for an iPad, the context of shopping is detected and reported to the sever with location information of the user. The Server matches relevant products according to user preference and characteristics and sends the agent commercial promotion to buy iPad at nearby stores, sorted by lowest price. The Agent pops up a message inside the calendar app which also has an agent with proposal to buy an iPad.

### Forth Scenario

The agent detects the following actions: the user opens up the Wired app which includes the agent inside, the user navigates into gadgets section and the agent reports the server. The sever matches relevant products according to user profile and sends the agent list of gadgets. The agent receives the list and waits for the right timing. The User leaves Wired app and shuts down the phone, after 2 hours, opens the Wired app again and reads a robotics article inside the gadgets section, the agent filters out the robotic related gadgets from the list of gadgets received previously and shows multiple advertisements to buy them at the end of the article.

### Fifth Scenario

The agent tracks, user opening up a cooking app which has small kitchen accessory shops within each recipe, the user goes into the recipe shop and navigates to a specific chapter (Meat) and the specific recipe itself (Pork Chops), next the user navigates to small shops and starts browsing through products, browse through product pages and once in a while clicks on a more info to view product rating and discounts. The Agent reports all user actions to the server indicating of higher interest in specific products where the user clicked more info. The server match relevant products based on user profile and sends products promotion list, accordingly the Agent reorganizes the next products to be seen in the shop based on the type of products the user has shown interest in.

### Six Scenario

According to this scenario the user is a runner and uses a running app with agent. The agent tracks when the user running performance, e.g. indicating the user is not in shape and reports it to the server together with the category of the app the user is using. The server match products related to reported activities and sends recommendation for a heart rate monitor which is important for people whom just begin running After two months the user improves his running skills and the agent continuously reports the improvement in performance. The server detects that user has risen to the next level and recommends tools for more professional runners.

### Seven Scenario

The user has installed a tourist app with agent according to the present invention and flies to France, the loves wine and while in France goes to wineries with the help of the app. The agent reports the sever the locations the user is interested in and their respective profile, and receiving matching products to advertise to the user, such as recommendation for a bottle opener and a journey log in a nice leather wrap.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

What is claimed is:

1. A method for matching products sale promotions for users while using an application in a computer device, said method comprising the steps of:
tracking user usage of application and/or usage of the computer device, including at least path of navigation, activities and context when using an application;
aggregating and analyzing usage data of each user in relation to at least one application for identifying behavior pattern, user characteristics and user preferences;
updating user profile based on identifying behavior pattern user characteristics and user preferences;
matching product commercial in real-time to user while using the application, based on his updated profile and current usage of the application according to predefined triggering rules.
wherein the process of tracking and updating and matching are performed by at least one processor unit.

2. The method of claim 1, wherein tracking user usage include measuring time usage parameters.

3. The method of claim 1 wherein tracking user usage includes measuring parameters of mobile device sensors or hardware elements.

4. The method of claim 1 wherein tracking user usage includes identifying interruptions in application usage including switching between applications.

5. The method of claim 1 wherein tracking user usage includes Identifying network connections.

6. The method of claim 1 wherein aggregating and analyzing usage data includes analyzing consumed content for classifying content, by applying at least one of: text parsing, image recognition, music/voice recognition.

7. The method of claim 1 wherein aggregating and analyzing usage data includes identifying and recording history/sequence of application activation, or simultaneous activation of multiple application.

8. The method of claim 1 wherein aggregating and analyzing usage data includes retrieving metadata information related running application including at least one of the following: category, description, reviews from network.

9. The method of claim 1 wherein the tracking is applied to multiple different applications installed on the same computer device and product matching is applied for a current running application of the same computer device.

10. The method of claim 1 wherein the product promotion is performed in real-time upon detecting the occurrence of predefined triggering timing rules based on user tracked activities.

11. A system for matching products sale promotions for users while using an application in a computer device, said system comprising of:
a commercial agent module residing on the computer device for tracking user usage of application and/or usage of the computer device, including at least path of navigation, activities and context when using an application;
a network server for aggregating and analyzing usage data of each user in relation to at least one application for identifying behavior pattern, user characteristics and user preferences updating user profile based on identifying behavior pattern user characteristics and user preferences and matching product commercial in real-time to user while using the application, based on his updated profile and current usage of the application according to predefined triggering rules.

12. The system of claim 11 wherein the commercial agent module is implemented as a designated application running on the computer device.

13. The system of claim 11 wherein the commercial agent module is implemented as a module associated with an application residing on the computer device.

14. The system of claim 11 wherein at least part of the identification and analysis steps are performed at the commercial agent at the computer device of the client

15. The system of claim 11 wherein tracking user usage includes identifying interruptions in application usage including switching between applications.

16. The system of claim 11 wherein aggregating and analyzing usage data includes analyzing consumed content for classifying content, by applying at least one of text parsing, image recognition, music/voice recognition.

17. The system of claim 11 wherein aggregating and analyzing usage data includes identifying and recording sequence of application activation, or simultaneous activation of multiple application.

18. The system of claim 11 wherein aggregating and analyzing usage data includes retrieving metadata information related running application including at least one of the following: category, description, reviews from network.

19. The system of claim 11 wherein the tracking is applied to multiple different applications installed on the same computer device and product matching is applied for a current running application of the same computer device.

20. The system of claim 11 wherein the product promotion is performed in real-time upon detecting the occurrence of predefined triggering timing rules based on user tracked activities.
